(19) United States
(12) Patent Application Publication
(10) Pub. No.: US 2024/0355528 A1
(43) Pub. Date: Oct. 24, 2024

(54) INTEGRATED TRANSFORMER WITH 3D LOW PERMEABILITY INSERTS

(71) Applicant: Raytheon Company, Waltham, MA (US)

(72) Inventors: Jeffrey Ewanchuk, Manchester, CT (US); Weilun Chen, Glastonbury, CT (US); Suman Dwari, Vernon, CT (US); Sriram Chandrasekaran, Lucas, TX (US)

(73) Assignee: Raytheon Company, Waltham, MA (US)

(21) Appl. No.: 18/136,079

(22) Filed: Apr. 18, 2023

(51) Int. Cl. H01F 27/28; H01F 27/24; H01F 41/02; H01F 41/06

(52) U.S. Cl. CPC H01F 27/28; H01F 27/24; H01F 41/0206; H01F 41/06

(57) ABSTRACT

An example integrated transformer is provided having a core. A first set of windings encircles a first region around the core. A second set of windings encircles a second region around the core, wherein the first region and the second region are not the same. At least one insert separates magnetic flux induced by the first set of windings and the second set of windings enabling increased magnetic inductance with reduced winding losses.

### BACKGROUND

RF power systems can feature multiple power converters and are under increased pressure to decrease size, weight, and power (SWAP). DC/DC soft-switched converters require discrete inductors external to the isolation transformers to achieve high efficiency and power density. Discrete resonant inductors require individual termination and are constrained by high voltage spacing requirements limiting the power density due to different footprints on printed circuit boards (PCBs) or substrates.

There is a need to provide an integrated resonant inductor and transformer assembly with 3D low permeability inserts to interface with the HV power electronic devices and secondary rectifier stage.

### SUMMARY

In one aspect, an example integrated transformer includes a core. A first set of windings encircles a first region around the core. A second set of windings encircles a second region around the core, wherein the first region and the second region are not the same. At least one insert separates magnetic flux induced by the first set of windings and the second set of windings enabling increased magnetic inductance with reduced winding losses. The at least one insert is positioned between the first set of windings and the second set of windings.

In some implementations, the core may include ferrite. The first set of windings may be inductor windings. The second set of windings may be transformer windings. The inductor windings and the transformer windings may be arranged in series. The at least one insert may include any of the following: magnetic powders in epoxy, 3D printed magnetic material, and sintered iron powder shapes. The at least one insert may include low permeability materials. The first set of windings and the second set of windings may be configured to produce an opposing flux distribution at the core. The first set of windings and the second set of windings may be configured to produce an additive flux distribution at the core.

In another aspect, an example electronic device includes a core. A resonant inductor is configured to have a first set of windings encircling a first region around the core. A transformer is configured to have a second set of windings encircling a second region around the core. The first region and the second region are not the same. At least one insert configured to reduce winding losses given the resonant inductor and the transformer. The at least one insert is positioned between the resonant inductor and the transformer.

In some implementations, the core may include ferrite. The first set of windings and the second set of windings may be arranged in series. The at least one insert may include any of the following: magnetic powders in epoxy, 3D printed magnetic material, and sintered iron powder shapes. The at least one insert may include low permeability materials. The first set of windings and the second set of windings may be configured to produce an opposing flux distribution at the core. The first set of windings and the second set of windings may be configured to produce an additive flux distribution at the core.

In another aspect, a method for implementing an integrated transformer is provided. The method includes fabricating a core. Also, the method includes encircling, with a first set of windings, a first region around the core. Moreover, the method includes encircling, with a second set of windings, a second region around the core. The first region and the second region are not the same. Furthermore, the method includes positioning at least one insert for increasing series inductance and reducing winding losses between the first set of windings and the second set of windings. The at least one insert is positioned between the first set of windings and the second set of windings.

In some implementations, the at least one insert may include low permeability materials. The method may include producing, using the first set of windings and the second set of windings, an opposing flux distribution at the core. The method may include producing, using the first set of windings and the second set of windings, an additive flux distribution at the core.

Additional features and advantages of the present disclosure is described in, and will be apparent from, the detailed description of this disclosure.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 is a schematic diagram of an example integrated resonant inductor and transformer assembly.

FIG. 2 is a schematic diagram of an example integrated resonant inductor and transformer assembly having a radial design.

FIGS. 3A-3B are schematic diagrams of the cross-sectional views of an example resonant inductor and transformer assembly.

FIGS. 4A-4B are graphs of simulated flux distributions of two different example winding arrangements.

FIGS. 5A-5B are graphs of performance results using an example resonant inductor and transformer assembly.

FIG. 6 is a process flowgraph of operations included in an example process 600 for implementing an integrated transformer.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

This disclosure describes an integrated resonant inductor and transformer assembly with 3D low-permeability inserts. The 3D low-permeability inserts allow for additional windings to achieve inductor/transformer integration. The low-permeability inserts reduce winding losses compared to air gaps, which must be large to keep inductor flux density low. Also, the resonant inductor and transformer assembly interfaces with the HV power electronic devices and secondary rectifier stages. Moreover, the resonant inductor and transformer assembly reduces the number of interconnection points, assembly costs, and overall footprint compared to the standard signal optical amplifiers (SOAs).

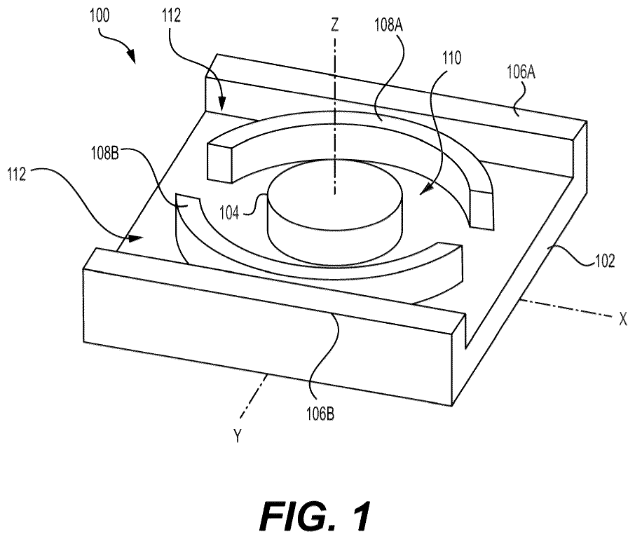

FIG. 1 is a schematic diagram of an example integrated resonant inductor and transformer assembly 100. The integrated resonant inductor and transformer assembly 100 includes a base 102, core 104, limb structures 106A and 106B, and inserts 108A and 108B. Moreover, resonant inductor and transformer assembly 100 may be based on a fabricated standard planar core, such as an ER planar core. Resonant inductor and transformer assembly 100 may comprise other planar core arrangements.

Base 102 provides structural support for core 104, limb structures 106A and 106B, and inserts 108A and 108B. The size of base 102 may depend on the size of the windings and the required power needed. Base 102 has a square, but in other implementations, base 102 may have a shape other than a square. Moreover, base 102 may comprise ferrite or other similar materials.

Core 104 is positioned on the central region of base 102. Core 104 comprises a cylindrical shape. Core 104 may include other shapes suitable for producing the needed magnetic flux in some implementations. Core 104 may have a height determined by the size of the windings used and the flux required. Core 104 is an integrated component of base 102. In some implementations, core 104 may be separate from base 102. Core 104 may include the same materials as base 102. In some instances, core 104 may include materials different from the materials of base 102.

Limb structures 106A and 106B are positioned at distal ends of base 102. Limb structures 106A and 106B extend horizontally in the x-direction. Limb structures 106A and 106B is an integrated component of base 102. In some implementations, limb structures 106A and 106B may be separate from base 102. Limb structures 106A and 106B may include the same materials as base 102. In some instances, limb structures 106A and 106B may consist of materials different from the materials of base 102.

Inserts 108A and 108B are semi-circular structures formed on base 102. In other implementations, inserts 108A and 108B may have a shape other than a semi-circle Region 110 between inserts 108A or 108B and core 104 defines the placement of the secondary windings forming the resonant inductor of resonant inductor and transformer assembly 100. Region 112, between inserts 108A or 108B and limbs 106A or 106B, is where the primary windings forming the transformer of resonant inductor and transformer assembly 100 are positioned. The secondary windings wrap in a circular fashion around region 110. In some implementations, the shape of the secondary windings may be other than circular. Moreover, the transformer windings may wrap in a circular fashion around region 112. In some implementations, the shape of the transformer windings may be different from circular. Inserts 108A and 108B are used to allow free routing of the primary/secondary windings.

Inserts 108A and 108B may include 3D low-permeability materials. The insert 108A and 108B may include any of the following: magnetic powders in epoxy, 3D printed magnetic material, and sintered iron powder shapes. Moreover, inserts 108A and 108B can reduce winding losses due to the use of low-permeability materials versus air gaps, which are required to be significant to keep inductor flux density low. Inserts 108A and 108B can allow one to reduce the overall transformer or inductor size due to lower losses by optimizing the shape of resonant inductor and transformer assembly 100 to maximize the utility of its magnetic components.

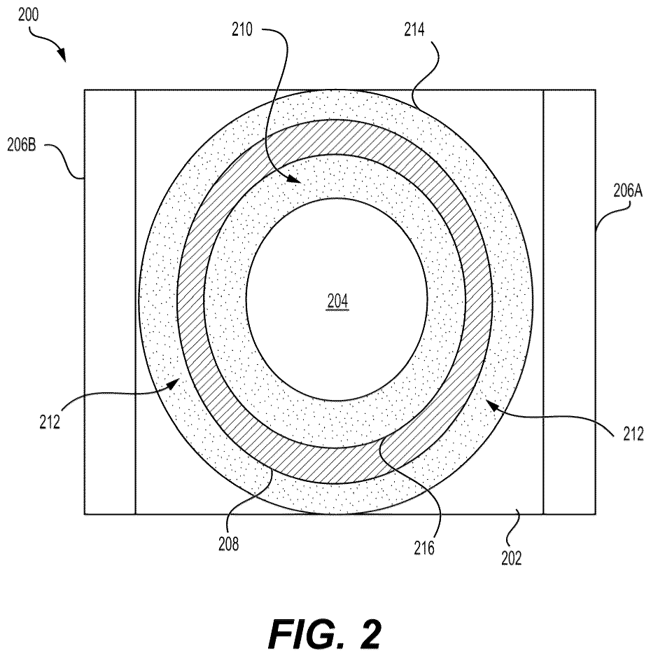

FIG. 2 is a schematic diagram of an example integrated resonant inductor and transformer assembly 200 having a radial design. The integrated resonant inductor and transformer assembly 200 includes a base 202, core 204, limb structures 206A and 206B, and insert 208. Moreover, resonant inductor and transformer assembly 200 may be based on a fabricated standard planar core, such as an ER planar core. Resonant inductor and transformer assembly 200 may be based on other planar core arrangements.

Base 202 provides structural support for core 204, limb structures 206A and 206B, and insert 208. The size of base 202 may depend on the size of the windings and the required power needed. Base 202 has a square shape, but in other implementations, base 202 may have a shape other than a square. Moreover, base 202 may comprise ferrite or other similar materials.

Core 204 is positioned in the central region of base 202. Core 204 comprises a cylindrical shape. Core 204 may include other shapes suitable for producing the needed magnetic flux in some implementations. Core 204 may have a height determined by the size of the windings used and the flux required. Core 204 is an integrated component of base 202. In some implementations, core 204 may be separate from base 202. Core 204 may include the same materials as base 202. In some instances, core 204 may include materials different from base 202.

Limb structures 206A and 206B are positioned at the distal ends of base 202. Limb structures 206A and 206B extend horizontally in the x-direction. Limb structures 206A and 206B are integrated components of base 202. In some implementations, limb structures 206A and 206B may be separate from base 202. Limb structures 206A and 206B may include the same materials as base 202. In some instances, limb structures 206A and 206B may consist of materials different from the materials of base 202.

Insert 208 is a closed radial structure formed on base 202. In other implementations, insert 208 may have a different closed shape, such as a rectangle or the like. An interior region 210 between insert 208 and core 204 defines the placement of the secondary windings 210 forming the resonant inductor of resonant inductor and transformer assembly 200. Region 212, between insert 208 and limbs 206A or 206B, is where the primary windings 214 of the transformer of resonant inductor and transformer assembly 200 are positioned. The secondary windings 216 encircles region 210. In some implementations, the shape of the secondary windings 216 may be other than circular. Also, the transformer windings may wrap in a circular fashion around region 212. In some implementations, the shape of the transformer windings may be different from circular. Insert 208 allow free routing of the primary/secondary windings.

Insert 208 may include 3D low-permeability materials. Moreover, insert 208 can reduce winding losses due to the use of 3D low permeability materials versus air gaps, which are required to be significant to keep inductor flux density low. The insert 208 may include any of the following: magnetic powders in epoxy, 3D printed magnetic material, and sintered iron powder shapes. Also, insert 208 can allow one to reduce the overall transformer and inductor size due to lower losses by optimizing the shape of resonant inductor and transformer assembly 200 to maximize the utility of its magnetic components.

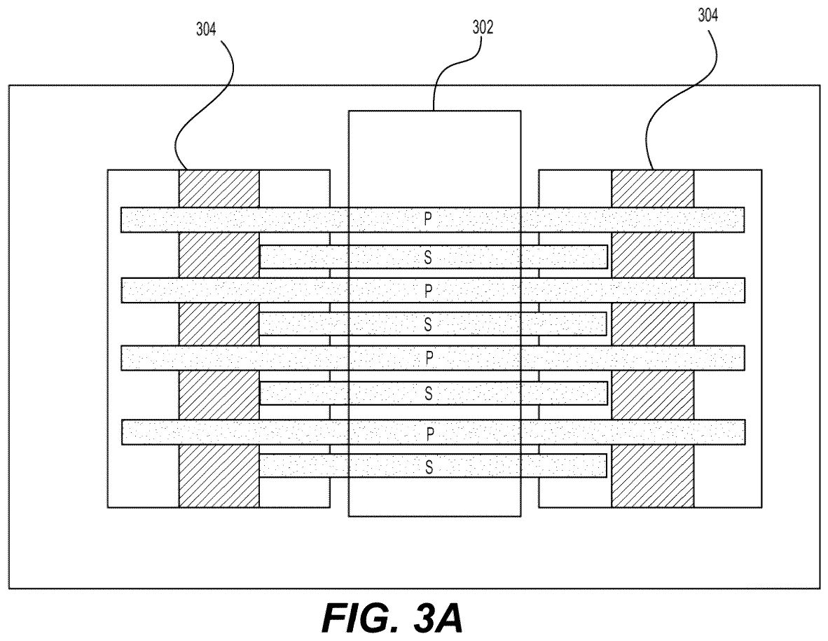

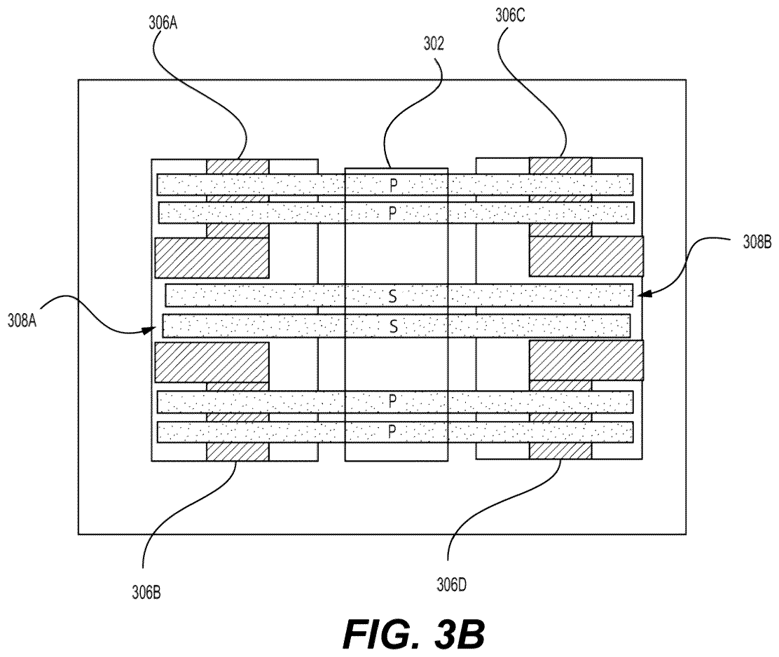

FIGS. 3A-3B are schematic diagrams of the cross-sectional views of an example resonant inductor and transformer assembly 300. Resonant inductor and transformer assembly 300 includes a core 302 and insert 304. Note resonant inductor and transformer assembly may be similar to resonant inductor and transformer assembly 100 or 200. Also, resonant inductor and transformer assembly 300 includes primary windings (P) used for magnetizing the transformer portion of assembly 300, and secondary winding (S) is used for implementing the resonant inductor portion of assembly 300. Resonant inductor and transformer assembly 300 may include two configurations, symmetric and asymmetric configurations, for implementing the primary winding (P) and second windings (S).

FIG. 3A shows resonant inductor and transformer assembly 300 having a symmetric winding configuration. In this instance, secondary windings (S) encircle core 302 and are positioned between insert 304 and core 302. The secondary windings (S) are the windings that define the resonant inductor for assembly 300. The primary windings (P) encircle the outer surface of insert 302. This indicates primary windings (P) may be longer and have a more significant radial distance to core 302. In some implementations, the radial distance between each secondary winding (S) and core 302 is double the radial distance between each primary wind (P) and core 302.

FIG. 3B shows resonant inductor and transformer assembly 300 having a asymmetric winding configuration. In this instance, resonant inductor and transformer assembly 300 include inserts 306A-306D. An opening 308A is between inserts 306A and 306B, and an opening 308B is between inserts 306C and 306D. In this instance, secondary windings (S) encircle a region where a portion of secondary windings (S) is positioned within openings 308A and 308B. Note secondary winding (S) does not extend beyond inserts 306A-306D. The primary windings (P) encircle the outer surface of inserts 306A-306D. Secondary windings (S) may be equal to or shorter than primary windings (P).

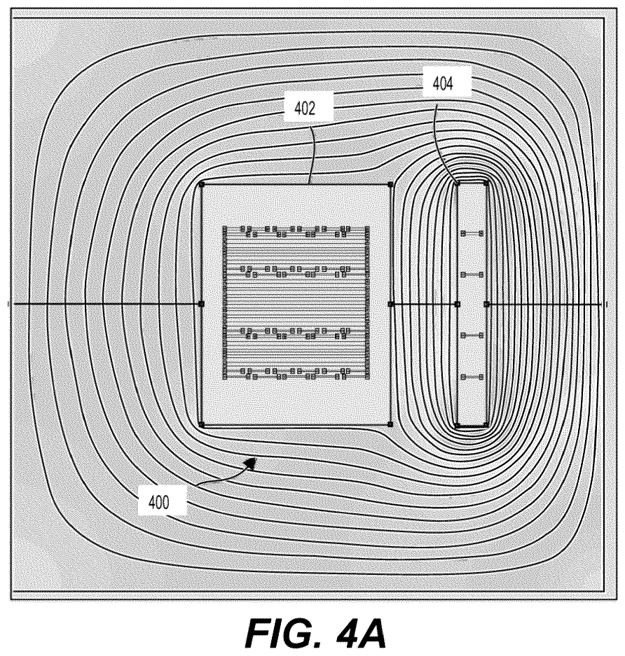

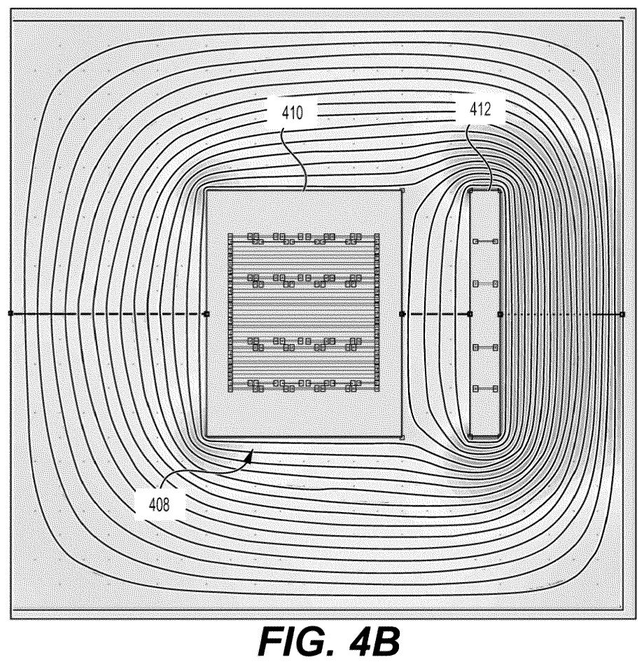

FIGS. 4A-4B are graphs of simulated flux distributions of two different example winding arrangements. In particular, FIG. 4A shows a cross-sectional representation of the simulated flux distribution of a resonant inductor and transformer assembly 400 having a symmetric winding configuration described in FIG. 3A. In this case, resonant inductor and transformer assembly 400 includes a core 402 and an insert 404. Moreover, resonant inductor and transformer assembly 400 produces an opposing flux distribution in core 402. To produce an opposing flux distribution in the core of a resonant inductor and transformer assembly whose windings have a symmetric winding configuration, one may arrange the windings to include the same orientation to magnetize the core for the transformer and the resonant inductor, possibly requiring a higher number of turns.

FIG. 4B shows a cross-sectional representation of the simulated flux distribution of a resonant inductor and transformer assembly 408 having a symmetric winding configuration described in FIG. 3B. In this case, resonant inductor and transformer assembly 408 includes a core 410 and an insert 412. Moreover, resonant inductor and transformer assembly 408 produces an additive flux distribution in core 410. To produce an additive flux distribution in the core of a resonant inductor and transformer assembly whose windings have a symmetric winding configuration requires assigning an orientation of the inductor windings to be opposite the primary windings.

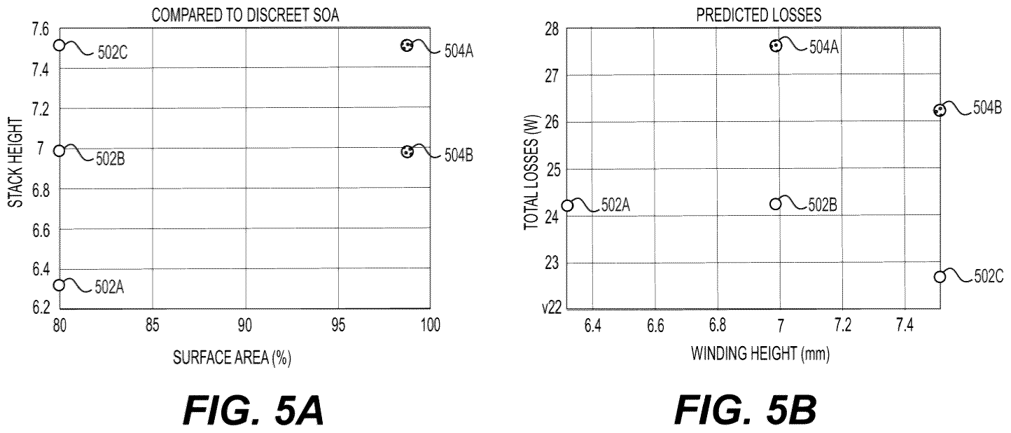

FIGS. 5A-5B are graphs of results using an example resonant inductor and transformer assembly. The predicted performance of several resonant inductor and transformer assemblies with 80-100% of the surface area compared to the SOA are shown in FIGS. 5A-5B. In particular, FIGS. 5A-5B show the performance results of resonant inductor and transformer assemblies 502A-502C and 504A-504B. Note resonant inductor and transformer assemblies 502A-502C have the same core size but different winding configurations, and resonant inductor and transformer assemblies 504A-504C have the same core size but different winding configurations.

In this case, FIG. 5A shows the relationship between surface area and stack height compared to the standard discreet SOA of several resonant inductor and transformer assemblies 502A-502C and 504A-504B. FIG. 5B shows the relationship between winding height and total losses compared to the predicted losses of several resonant inductor and transformer assemblies 502A-502C and 504A-504B. Based on the results, the integrated resonant inductor and transformer assemblies described herein can reduce the overall surface area by up to 80% with an acceptable temperature rise.

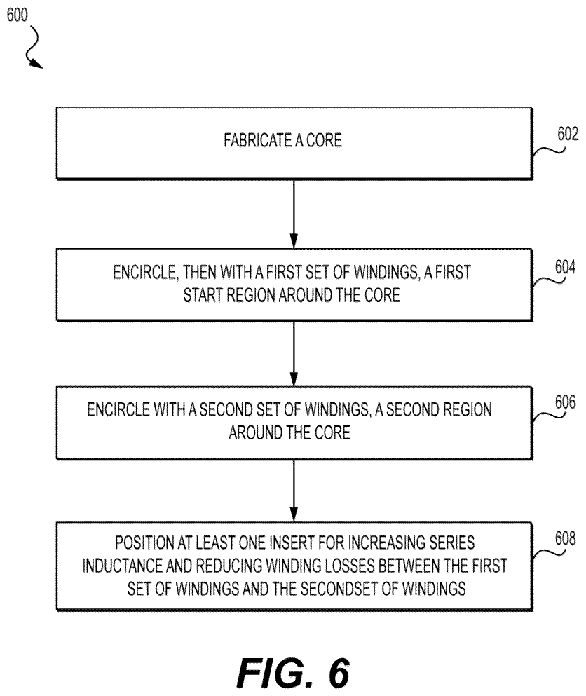

FIG. 6 is a process flowgraph of operations included in an example process 600 for implementing an integrated transformer. Process 600 includes fabricating a core (such as core 104, 204, or 302) (Step 602). The fabrication process of the core may include fabricating a standard planar core, such as an ER planar core. Process 600 includes encircling, with a first set of windings (such as secondary windings S), a first region (such as region 110) around the core (Step 604). The first set of windings may be inductor windings forming a resonant inductor.

Process 600 includes encircling, with a second set of windings (such as secondary windings 210 or S), a second region (such as region 112) around the core (Step 606). The first region and the second region are not the same. The second set of windings may be transformer windings forming a transformer. Moreover, process 600 includes positioning at least one insert (such as insert 108A, 108B, 208, 304, or 306A-306D, or 404) for reducing winding losses between the first set of windings and the second set of windings (Step 608). The at least one insert is positioned between the first set of windings and the second set of windings.

In some implementations, the core may include ferrite. The inductor windings and the transformer windings may be arranged in series. The at least one insert may include any of the following: magnetic powders in epoxy, 3D printed magnetic material, and sintered iron powder shapes. The at least one insert may include low permeability materials. The first set of windings and the second set of windings may be configured to produce an opposing flux distribution at the core. The first set of windings and the second set of windings may be configured to produce an additive flux distribution at the core.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in one embodiment,” or “in some embodiments” in various places in the specification are not necessarily all referring to the same implementation or embodiment.

Finally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the present disclosure is intended to be illustrative, but not limiting, of the scope of the present disclosure, which is set forth in the following claims.

What is claimed is:

1. An integrated transformer comprising:
a core;
a first set of windings encircling a first region around the core;
a second set of windings encircling a second region around the core, wherein the first region and the second region are not the same; and
at least one insert separating magnetic flux induced by the first set of windings and the second set of windings enabling increased magnetic inductance with reduced winding losses.

2. The integrated transformer of claim 1, wherein the core comprises ferrite.

3. The integrated transformer of claim 1, wherein the first set of windings are inductor windings.

4. The integrated transformer of claim 3, wherein the second set of windings are transformer windings.

5. The integrated transformer of claim 4, wherein the inductor windings and the transformer windings are arranged in series.

6. The integrated transformer of claim 1, wherein the at least one insert comprises any of the following: magnetic powders in epoxy, 3D printed magnetic material, and sintered iron powder shapes.

7. The integrated transformer of claim 1, wherein the at least one insert comprises low permeability materials.

8. The integrated transformer of claim 1, wherein the first set of windings and the second set of windings are configured to produce an opposing flux distribution at the core.

9. The integrated transformer of claim 1, wherein the first set of windings and the second set of windings are configured to produce an additive flux distribution at the core.

10. An electronic device comprising:
a core;
a resonant inductor configured to have a first set of windings encircling a first region around the core;
a transformer configured to have a second set of windings encircling a second region around the core, wherein the first region and the second region are not the same; and
at least one insert configured to reduce winding losses given the resonant inductor and the transformer, wherein the at least one insert is positioned between the resonant inductor and the transformer.

11. The electronic device of claim 10, wherein the core comprises ferrite.

12. The electronic device of claim 10, wherein the first set of windings and the second set of windings are arranged in series.

13. The electronic device of claim 10, wherein the at least one insert comprises any of the following: magnetic powders in epoxy, 3D printed magnetic material, and sintered iron powder shapes.

14. The electronic device of claim 10, wherein the at least one insert comprises low permeability materials.

15. The electronic device of claim 10, wherein the first set of windings and the second set of windings are configured to produce an opposing flux distribution at the core.

16. The electronic device of claim 10, wherein the first set of windings and the second set of windings are configured to produce an additive flux distribution at the core.

17. A method for implementing an integrated transformer, the method comprising:
fabricating a core;
encircling, with a first set of windings, a first region around the core;
encircling, with a second set of windings, a second region around the core, wherein the first region and the second region are not the same; and
positioning at least one insert for increasing series inductance and reducing winding losses between the first set of windings and the second set of windings, wherein the at least one insert is positioned between the first set of windings and the second set of windings.

18. The method of claim 17, wherein the at least one insert comprises low permeability materials.

19. The method of claim 17, further comprising producing, using the first set of windings and the second set of windings, an opposing flux distribution at the core.

20. The method of claim 17, further comprising producing, using the first set of windings and the second set of windings, an additive flux distribution at the core.
